(19) United States
(12) Patent Application Publication
(10) Pub. No.: US 2012/0109574 A1
(43) Pub. Date: May 3, 2012

(54) Multi-dimensional vector determining circuit in a sensor integrated circuit package

(76) Inventor: Mihai-Costin Manolescu, San Jose, CA (US)

(21) Appl. No.: 12/925,708

(22) Filed: Oct. 27, 2010

(51) Int. Cl. G06F 15/00; G01P 15/00

(52) U.S. Cl. 702/141

(57) ABSTRACT

A sensor integrated circuit package with a Multi-Dimensional Vector Determining Circuit (MDVDC) determines a resultant vector by processing vector component magnitudes detected by the sensor. For example, an accelerometer integrated circuit package contains a sensing circuit, an Analog-to-Digital Converter (ADC), and a MDVDC. The sensing circuit generates a first signal representing an acceleration vector component of the accelerometer along a first axis and generates a second signal representing an acceleration vector component of the accelerometer along a second orthogonal axis. The ADC converts both signals into digital logic values. The MDVDC uses the digital logic values that represent the acceleration vector components to determine a resultant acceleration vector representing the precise acceleration magnitude and direction of the accelerometer. The accelerometer generates an interrupt signal when the resultant acceleration vector magnitude is above a pre-defined threshold value (during a shake condition), or below a pre-defined threshold value (during a free-fall condition).

### TECHNICAL FIELD

The present invention relates generally to sensors, and more specifically to processing information detected by sensors.

### BACKGROUND INFORMATION

Sensors are often used in electronic devices in order to detect physical conditions such devices may undergo. One common type of sensor is an acceleration sensor, or accelerometer, typically found in an electronic device that responds or functions in a particular way when the device is accelerated beyond a threshold magnitude. Typically such a device includes a microcontroller and an accelerometer, and the accelerometer provides acceleration information of the device to the microcontroller. The microcontroller can analyze this acceleration information to determine whether the device is being accelerated, and in some conditions will alter the operation of the device in response to being accelerated. For example, the microcontroller can process acceleration information determined by the accelerometer to determine whether the device is being shaken beyond a certain magnitude of acceleration, and the microcontroller can control the function of the device to respond to such a shake condition. However, in some circumstances the microcontroller fails to detect when the device is undergoing a particular condition, such as failing to detect the device being shaken. Moreover, the processing of acceleration information by the microcontroller can become computationally costly. An improved solution is desired.

### SUMMARY

A sensor integrated circuit package with a Multi-Dimensional Vector Determining Circuit (MDVDC) determines a resultant vector by processing vector component magnitudes detected and generated by the sensor. For example, an accelerometer with a MDVDC determines a resultant acceleration vector that represents a precise acceleration magnitude and direction of the accelerometer. The accelerometer with an MDVDC includes an integrated circuit package containing a sensing circuit, an Analog-to-Digital Converter (ADC), and the MDVDC. The sensing circuit includes a first sensing element and a second sensing element, and each sensing element is configured to detect acceleration of the accelerometer along an orthogonal axis. When the accelerometer is accelerated, the sensing circuit generates a first signal representing an acceleration vector component of the accelerometer along a first axis and also generates a second signal representing an acceleration vector component of the accelerometer along a second orthogonal axis. The ADC converts each signal representing the acceleration vector components into multi-bit digital logic values. The MDVDC uses the multi-bit digital logic values that represent the acceleration vector components to determine a resultant acceleration vector representing the precise acceleration magnitude and direction of the accelerometer.

The accelerometer with the MDVDC is configurable to generate interrupt signals when the accelerometer undergoes pre-defined conditions. One type of pre-defined condition is a high-G condition or a shake condition, which may occur when the accelerometer is shaken. Another type of pre-defined condition is a free fall condition, which may occur when the accelerometer is dropped. The interrupt signal is configurable to be supplied onto an output terminal of the integrated circuit package.

In one example, an accelerometer with an MDVDC is integrated in an electronic device, in accordance with one novel aspect. A microcontroller of the device is configured to receive an interrupt signal from a terminal of the accelerometer when the device is shaken beyond a certain threshold, and is also configured to receive a separate interrupt signal from a terminal of the accelerometer when the device is in free fall. Additionally, the microcontroller is configured to read multi-bit digital logic values from registers of the accelerometer via a serial bus. For example, if the device is accelerated, the microcontroller can receive a multi-bit digital logic value from the accelerometer that represents precise acceleration magnitude of the device by performing a read operation via the serial bus. Similarly, the microcontroller can read other information determined by the accelerometer, such as the acceleration direction or acceleration magnitudes along various axes. The microcontroller is also configured to write to registers of the accelerometer via the serial bus. For example, the microcontroller performs a write operation to set a threshold value for a shake condition such that an interrupt signal will be supplied to the microcontroller when the acceleration magnitude is above the threshold value. Similarly, the microcontroller can perform a write operation via the serial bus in order to set a threshold value for a free fall condition.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a diagram of an electronic device that includes an accelerometer 100 with a Multi-Dimensional Vector Determining Circuit (MDVDC) in accordance with one novel aspect.

FIG. 2 is a more detailed block diagram of accelerometer 100 and microcontroller 103 showing communication between both devices via serial bus 104 and interrupt conductors 120 and 121.

FIG. 3 is a more detailed diagram of novel accelerometer 100.

FIG. 4 is a more detailed circuit diagram of sensing circuit 131 that includes sensing elements configured to detect acceleration vector component magnitudes along orthogonal axes.

FIG. 5 is a detailed circuit diagram of processing circuit 133, containing the MDVDC 135 that determines the resultant acceleration vector representing motion of accelerometer 100.

FIG. 6 is a simplified diagram of MDVDC 135 that determines a resultant acceleration vector by performing computations on the vector component magnitudes detected by sensing circuit 131.

FIG. 7 is a detailed block diagram of interrupt circuit 161 of FIG. 5 that generates interrupt signals INT1 and INT2 when accelerometer 100 undergoes pre-defined conditions.

FIG. 8 is a diagram of a user shaking cellular phone 101 of FIG. 1, and causing interrupt circuit 161 to generate an interrupt signal indicating a shake condition.

FIG. 9 is a diagram of the resultant acceleration vector representing the motion of cellular phone 101 at an instant in time during the shake condition of FIG. 8.

FIG. 10 is a table that shows the acceleration vector component magnitudes and the resultant acceleration vector magnitude representing the motion of cellular phone 101 at an instant in time during the shake condition of FIG. 8.

FIG. 11 is a graph demonstrating the condition detection error in two-dimensions when each vector component is processed independently as opposed to determining the resultant acceleration vector for detecting a condition.

FIG. 12 is a diagram of an accelerometer 210 in a laptop 211 configured to generate an interrupt signal during a free fall condition, in accordance with one novel aspect.

FIG. 13 is a diagram of laptop 211 falling off of a surface and in a free fall condition.

FIG. 14 is a diagram of the resultant acceleration vector representing the motion of laptop 211 at an instant in time during the free fall condition of FIG. 13.

FIG. 15 is a table that shows the vector component magnitudes and the resultant acceleration vector magnitude representing the motion of laptop 211 at an instant in time during the free fall condition of FIG. 13.

FIG. 16 is a flowchart 300 in accordance with one novel aspect.

Reference will now be made in detail to some embodiments of the invention, examples of which are illustrated in the accompanying drawings.

### DETAILED DESCRIPTION

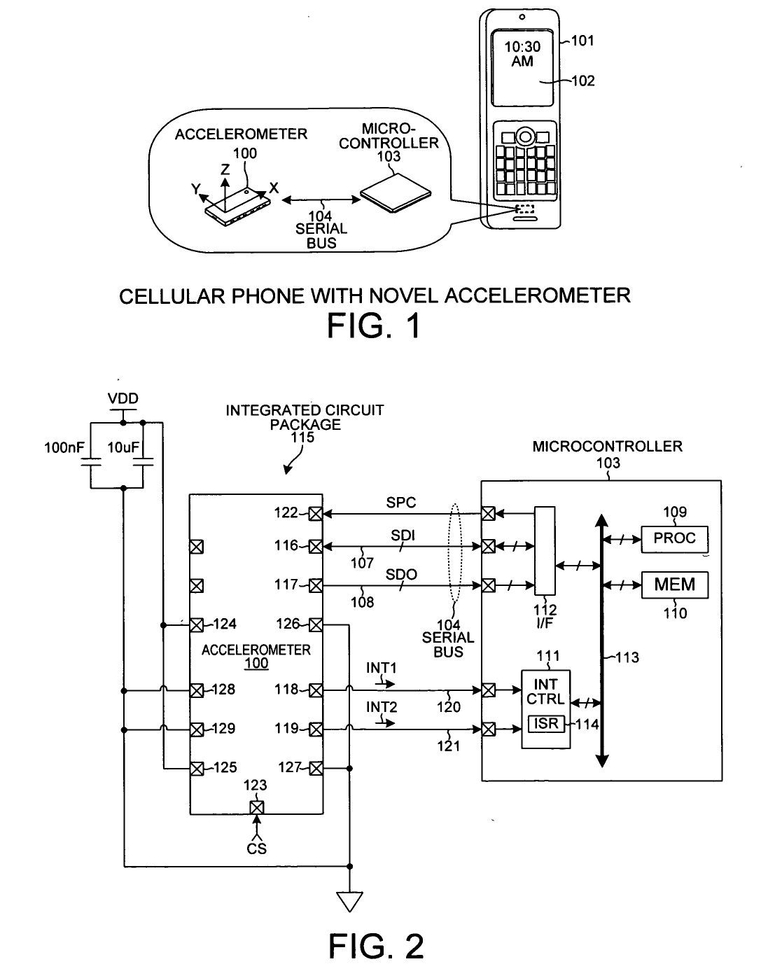

FIG. 1 is a diagram of an electronic device that includes an accelerometer 100 with a Multi-Dimensional Vector Determining Circuit (MDVDC) in accordance with one novel aspect. Accelerometer 100 is configured to determine precise acceleration magnitude and direction information of the electronic device. Typically, accelerometer 100 is sensitive to acceleration between the range of ±2 G to ±8 G. In this example, the electronic device is a cellular phone 101 that is sensitive to motion under certain conditions. For example, if cellular phone 101 is shaken so that its magnitude of acceleration exceeds a pre-defined shake threshold value, then cellular phone 101 renders a different screen on display 102. Cellular phone 101 also includes microcontroller 103, and microcontroller 103 is configured to receive interrupt signals generated by accelerometer 100, as well as perform read operations and write operations on accelerometer 100 via serial bus 104.

FIG. 2 is a more detailed block diagram of accelerometer 100 and microcontroller 103 showing communication between both devices via serial bus 104 and interrupt conductors 120 and 121. During a write operation, microcontroller 103 writes a multi-bit digital logic value onto a register of accelerometer 100 via conductors 107 of serial bus 104. During a read operation, microcontroller 103 receives a multi-bit digital logic value from a register of accelerometer 100 via conductors 108 of serial bus 104. In this example, microcontroller 103 includes processor 109, memory portion 110, interrupt controller 111, serial bus interface block 112, and internal data bus 113. Interrupt controller 111 further includes Interrupt Service Routine (ISR) portion 114.

Integrated circuit package 115 simplifies integration of novel accelerometer 100 in electronic devices, in accordance with one novel aspect. Integrated circuit package 115 includes terminals 116 and 117 supporting read and write operations across serial bus 104, and also includes terminals 118 and 119 that conduct interrupt signals supplied onto conductors 120 and 121. Terminal 122 receives a clock signal SPC, and terminal 123 receives a signal Chip Select (CS) that determines a communication mode of accelerometer 100. Integrated circuit package 115 additionally includes a plurality of terminals used to provide power and ground to circuitry of the accelerometer. For example, accelerometer 100 of FIG. 2 receives VDD onto terminal 124 and 125, and terminals 126-129 are coupled to ground. Accelerometer 100 can operate when VDD is within the range of 2.16V to 3.6V, but VDD is typically 2.5V. Typically the integrated circuit package is a Dual In-line Package (DIP), a Quad Flat Pack (QFP), a Bumpered Quad Flat Pack (BQFP), a Ceramic Flat Pack (CFP), a Ceramic Quad Flat Pack (CQFP), a Dual Flat Pack (DFP), an Extra Thin Quad Flat Package (ETQFP), a Low-profile Quad Flat Package (LQFP), Plastic Quad Flat Pack (PQFP), a Land Grid Array (LGA) package, or a Ball Grid Array (BGA) package. The enumerated packages serve as examples of potential packages for explanatory purposes, and integrated circuit package 115 is not limited to these.

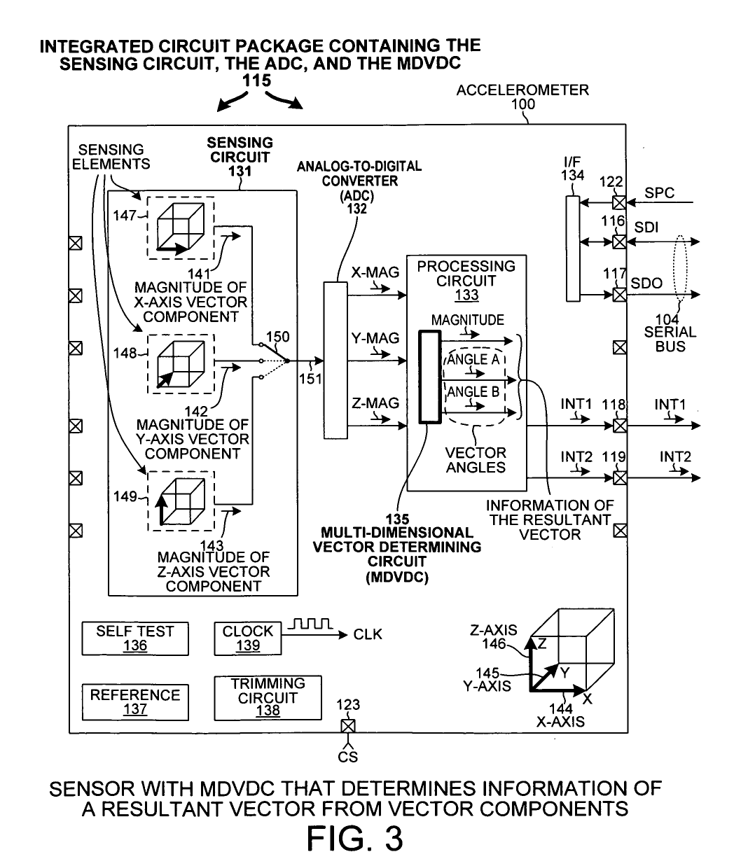

FIG. 3 is a more detailed diagram of novel accelerometer 100. Accelerometer 100 includes an integrated circuit package 115 that contains a sensing circuit 131, an Analog-to-Digital Converter (ADC) 132, a processing circuit 133, and a serial bus interface block 134. Processing circuit 133 further includes a Multi-Dimensional Vector Determining Circuit (MDVDC) 135 that determines a resultant acceleration vector representing the precise acceleration of accelerometer 100. The resultant acceleration vector represents the motion of accelerometer 100 at an instant in time by indicating both a magnitude and a direction of acceleration. Accelerometer 100 further includes a self test block 136, a reference block 137, a trimming circuit block 138, and internal clock 139.

In operation, sensing circuit 131 generates signals 141, 142, and 143 representing acceleration vector component magnitudes, and signals 141, 142 and 143 are then converted into multi-bit digital logic values processable by MDVDC 135. Each acceleration vector component magnitude represents a magnitude of acceleration of accelerometer 100 along an orthogonal axis, such as X-axis 144, a Y-axis 145, or a Z-axis 146. Sensing circuit 131 includes sensing elements 147, 148 and 149 that detect acceleration along an axis and generate signals that represent each acceleration vector component along the corresponding axis. For example, sensing element 147 generates a signal representing a magnitude of acceleration of accelerometer 100 along X-axis 144. Sensing circuit 131 then supplies the signals 141, 142, and 143 to ADC 132 via switch 150 and conductor 151. ADC 132 converts signals 141, 142 and 143 into multi-bit digital logic values X-MAG, Y-MAG, and Z-MAG.

MDVDC 135 of accelerometer 100 determines a resultant acceleration vector representing acceleration of the accelerometer 100 by computing a vector sum of acceleration vector components. Processing circuit 133 receives multi-bit digital logic values X-MAG, Y-MAG, and Z-MAG generated by ADC 132, and MDVDC computes a magnitude and direction of the resultant acceleration vector using the multi-bit digital logic values. In this example, the computed magnitude and direction of the resultant acceleration vector are represented as 8-bit digital values and are stored in registers of accelerometer 100.

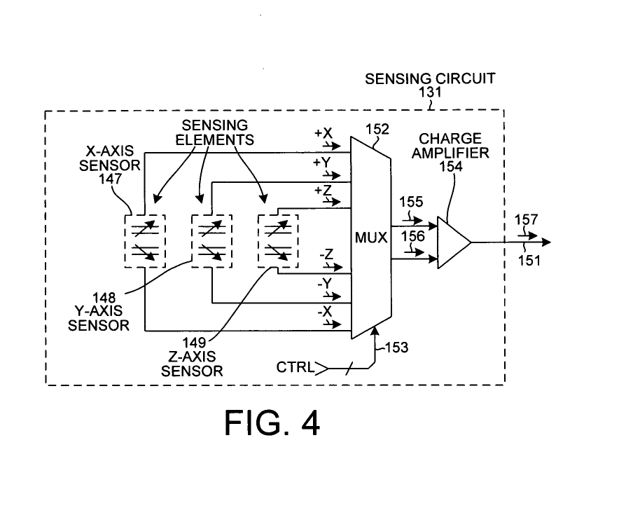

FIG. 4 is a more detailed circuit diagram of sensing circuit 131 that includes sensing elements configured to detect acceleration vector component magnitudes along orthogonal axes. In this example, sensing circuit 131 includes three sensing elements 147, 148, and 149. Sensing element 147 is configured to detect a magnitude of acceleration of accelerometer 100 along the X-axis 144. Sensing element 148 is configured to detect a magnitude of acceleration of accelerometer 100 along the Y-axis 145. Sensing element 149 is configured to detect a magnitude of acceleration of accelerometer 100 along the Z-axis 146. Sensing elements 147, 148, and 149 generate a positive and negative charge representing magnitudes of acceleration along each axis. The positive and negative charges are selected by MUX 152 controllable by signal CTRL supplied onto conductor 153. Charge amplifier 154 converts positive charge 155 and negative charge 156 into an analog signal 157 supplied onto conductor 151. The voltage of signal 157 indicates the magnitude of the vector component. For further details on the structure and operation of sensing circuitry and how to make sensor circuit 131, see: U.S. Pat. No. 6,753,691 issued to Lasalandra et al. (the subject matter of which is incorporated herein by reference), and U.S. Pat. No. 6,940,632 issued to Kipp et al. (the subject matter of which is incorporated herein by reference).

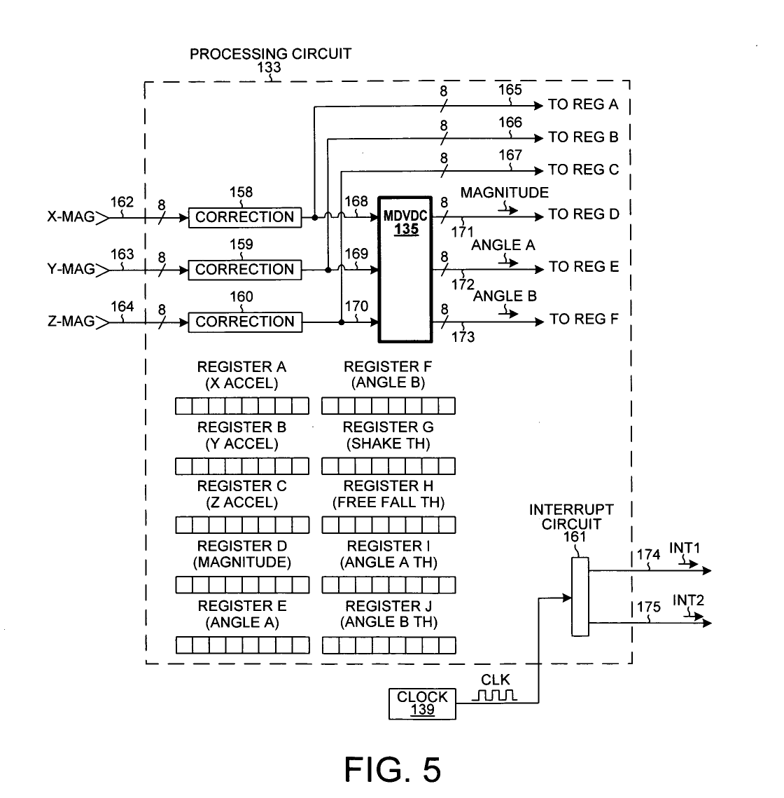

FIG. 5 is a detailed circuit diagram of processing circuit 133, containing the MDVDC 135 that determines the resultant acceleration vector representing motion of accelerometer 100. Processing circuit 133 includes correction blocks 158-160, MDVDC 135, interrupt circuit 161, and registers (A-J). Processing circuit 133 receives signal X-MAG onto conductor 162, signal Y-MAG onto conductor 163, and signal Z-MAG onto conductor 164. Signal X-MAG represents the vector component magnitude of acceleration along the X-axis 144, signal Y-MAG represents the vector component magnitude of acceleration along the Y-axis 145, and signal Z-MAG represents the vector component magnitude of acceleration along the Z-axis 146. Signals X-MAG, Y-MAG, and Z-MAG are digitally processed and filtered by correction blocks 158, 159, and 160, and the corrected signals X-MAG CORR, Y-MAG CORR, and Z-MAG CORR are stored in REGISTER A, REGISTER B, and REGISTER C, via conductors 165, 166, and 167, respectively. In this example, each value is stored as an 8-bit digital logic value. Corrected signals X-MAG CORR, Y-MAG CORR, and Z-MAG CORR are supplied to MDVDC 135, via conductors 168, 169, and 170, respectively. MDVDC 135 generates an 8-bit digital logic value representing the magnitude of acceleration at an instant in time of accelerometer 100, and stores this value, MAGNITUDE, in REGISTER D via conductors 171. MDVDC 135 additionally generates two 8-bit digital logic values, ANGLE A and ANGLE B, representing the direction of acceleration at an instant in time of accelerometer 100, and stores these values in REGISTER E and REGISTER F, via conductors 172 and 173, respectively. Interrupt circuit 161 receives clock signal CLK generated by clock 139, and if accelerometer 100 undergoes certain conditions, then interrupt circuit 161 generates and supplies interrupt signals INT1 and INT2 onto interrupt output leads and conductors 174 and 175, respectively.

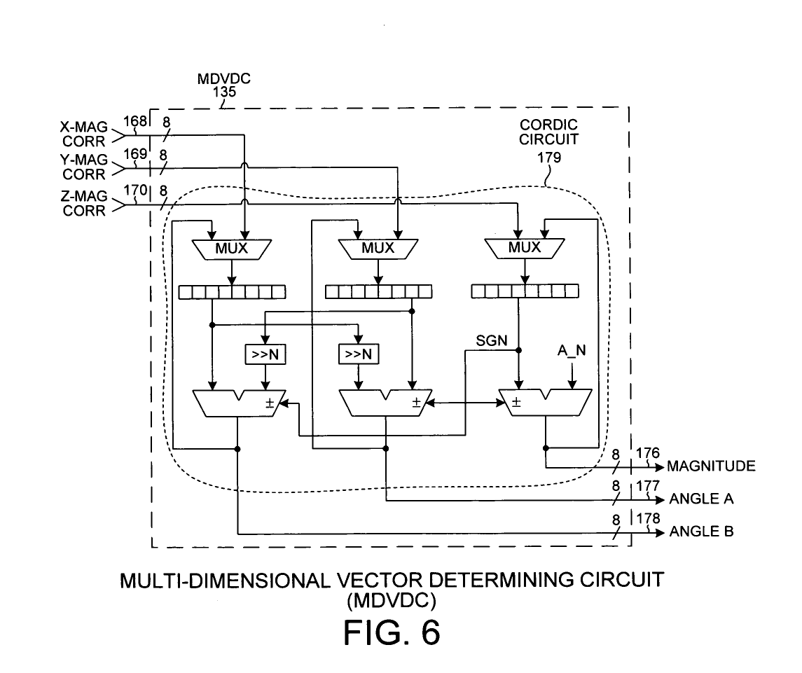

FIG. 6 is a simplified diagram of MDVDC 135 that determines a resultant acceleration vector by performing computations on the vector component magnitudes detected by sensing circuit 131. MDVDC 135 receives signal X-MAG CORR via conductors 168, signal Y-MAG CORR via conductors 169, and Z-MAG CORR via conductors 170. MDVDC 135 is a digital logic circuit that determines a resultant acceleration vector using the vector component magnitudes of acceleration corresponding to the movement of accelerometer 100 at an instant in time. Information of the resultant acceleration vector is represented by multi-bit digital logic values that indicate its magnitude and direction. MDVDC 135 is said to have “multi-dimensional” functionality because it can compute a resultant acceleration vector in two-dimensions or in three-dimensions. MDVDC 135 determines the information without executing any instructions, and MDVDC 135 is an amount of dedicated hardwired circuitry, and includes no processor capable of executing instructions and no user programmable data flow. Details of the computations involved in determining the resultant acceleration vector are described below.

To compute a magnitude of the resultant acceleration vector, MDVDC 135 applies the Pythagorean theorem to compute a Euclidean distance that represents this magnitude. In two dimensions, for example the two-dimensional plane involving X-axis 144 and Y-axis 145, computing the magnitude of acceleration typically involves finding the sum of each squared vector component magnitude, (X-MAG CORR)²+(Y-MAG CORR)², and then computing the square root of the resulting summation. In three dimensions, computing the magnitude of acceleration typically involves finding the sum of each squared vector component magnitude, (X-MAG CORR)²+(Y-MAG CORR)²+(Z-MAG CORR)², and then computing the square root of the resulting summation. In this example, the computed resultant acceleration vector magnitude is represented as an 8-bit digital logic value, MAGNITUDE, and is stored in REGISTER D via conductors 176.

To compute the direction of the resultant acceleration vector, MDVDC 135 computes the arctangent of the ratio between vector component magnitudes. In two dimensions, for example the two-dimensional plane involving X-axis 144 and Y-axis 145, the direction is determined by computing arctangent (Y-MAG CORR/X-MAG CORR). In this example, the computed resultant acceleration vector direction, ANGLE A, is represented by an 8-bit digital logic value and is stored in REGISTER E via conductors 177. In three dimensions, two computations are involved in determining the direction of the resultant acceleration vector. First, MDVDC 135 computes arctangent (Y-MAG CORR/X-MAG CORR) and stores the result, ANGLE A, as an 8-bit digital logic value in REGISTER E via conductors 177, as in the two-dimensional example. Second, MDVDC 135 computes arctangent (Z-MAG CORR/Y-MAG CORR) and stores the result, ANGLE B, as an 8-bit digital logic value in REGISTER F via conductors 178. If the resultant acceleration vector is represented in three dimensions, then two multi-bit digital logic values are used to indicate the direction, whereas only one multi-bit digital logic value is needed to indicate the direction if the resultant acceleration vector is represented in two dimensions.

In this specific example, MDVDC 135 uses a structure known as COordinate Rotation DIgital Computer (CORDIC) circuit. The CORDIC circuit is an efficient structure for computing common mathematical and trigonometric functions. CORDIC circuit 179 of FIG. 6 is a simplified example of such a circuit. The CORDIC circuit in MDVDC 135 is but one technique for determining the resultant acceleration vector. For further details on the structure and operation of a CORDIC circuit and how to make circuit 179, see: U.S. Pat. No. 7,606,852, issued to Maharatna et al. (the subject matter of which is incorporated herein by reference), and U.S. Pat. No. 6,385,632, issued to Choe et al. (the subject matter of which is incorporated herein by reference).

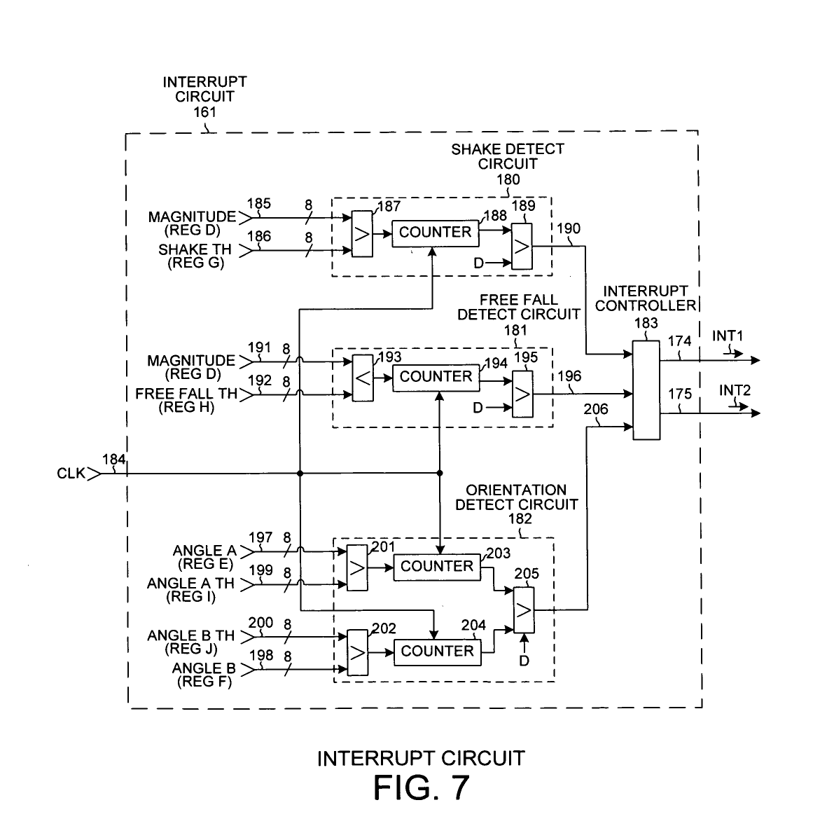

FIG. 7 is a detailed block diagram of interrupt circuit 161 of FIG. 5 that generates interrupt signals INT1 and INT2 when accelerometer 100 undergoes pre-defined conditions. Interrupt circuit 161 includes a shake detect circuit 180, a free fall detect circuit 181, an orientation detect circuit 182, and an interrupt controller 183. Interrupt circuit 161 receives clock signal CLK from clock 139 of FIG. 5 onto conductor 184. In some circumstances, interrupt controller 161 asserts digital logic value INT1 to a digital logic high value supplied onto conductor 174, and in other circumstances asserts INT2 to a digital logic high value supplied onto conductor 175.

Shake detect circuit 180 detects a shake condition by determining the number of clock cycles for which the magnitude of the resultant acceleration vector exceeds a shake threshold value. In this example, microcontroller 103 sets the shake threshold value by writing a multi-bit digital logic value corresponding to 1.2 G onto a shake threshold register (REGISTER G) via serial bus 104. Shake detect circuit 180 reads the 8-bit digital logic value representing a magnitude of a resultant acceleration vector from REGISTER D via conductors 185, and also receives an 8-bit digital logic value representing a shake threshold value from REGISTER G via conductor 186. The magnitude of the resultant acceleration vector is compared to the shake threshold value by comparator 187, and the number of clock cycles of signal CLK for which the magnitude exceeds the shake threshold is counted by counter 188. If comparator 189 determines the clock cycle count exceeds a duration value D, then shake detect circuit 180 asserts a digital logic high value on conductor 190 and interrupt controller 183 generates an interrupt signal signifying a shake condition. The interrupt signal generated during a shake condition may be INT1 via conductor 174, or may be INT2 via conductor 175, depending on the configuration of interrupt controller 183.

Free fall detect circuit 181 detects a free fall condition by determining the number of clock cycles for which the magnitude of the resultant acceleration vector is less than a free fall threshold value. In this example, microcontroller 103 sets the free fall threshold value by writing a multi-bit digital logic value corresponding to 0.7 G onto a free fall threshold register (REGISTER H) via serial bus 104. Free fall detect circuit 181, reads an 8-bit digital logic value representing a magnitude of a resultant acceleration vector from REGISTER D via conductors 191, and also receives an 8-bit digital logic value representing a free fall threshold value from REGISTER H via conductors 192. The magnitude of the resultant acceleration vector is compared to the free fall threshold value by comparator 193, and the number of clock cycles of signal CLK for which the magnitude is less than the free fall threshold, which is 0.7 G in this example, is counted by counter 194. If comparator 195 determines the clock cycle count exceeds a duration value D, then free fall detect circuit asserts a digital logic high value onto conductor 196 and interrupt controller 183 generates an interrupt signal signifying a free fall condition. The interrupt signal generated during a free fall condition may be INT1 via conductor 174, or may be INT2 via conductor 175, depending on the configuration of interrupt controller 183.

Orientation detect circuit 182 detects an orientation change condition by determining the number of clock cycles for which the ANGLE A and ANGLE B are greater than threshold values. Orientation detect circuit 182, receives an 8-bit digital logic values representing direction of a resultant acceleration vector from REGISTER E and REGISTER F via conductors 197 and 198, respectively, and also receives multi-bit digital logic values representing angle threshold values from REGISTER I and REGISTER J via conductors 199 and 200, respectively. The angle values of the resultant acceleration vector are compared to their associated threshold angle values by comparators 201 and 202, and the number of clock cycles of signal CLK for which the angles exceed the threshold angles are counted by counters 203 and 204, respectively. If comparator 205 determines the clock cycle counts exceed duration value D, then orientation detect circuit 182 asserts a digital logic high value on conductor 206 and interrupt controller generates an interrupt signal signifying an orientation change condition. The interrupt signal generated during an orientation change condition may be INT1 via conductor 174, or may be INT2 via conductor 175, depending on the configuration of interrupt controller 183.

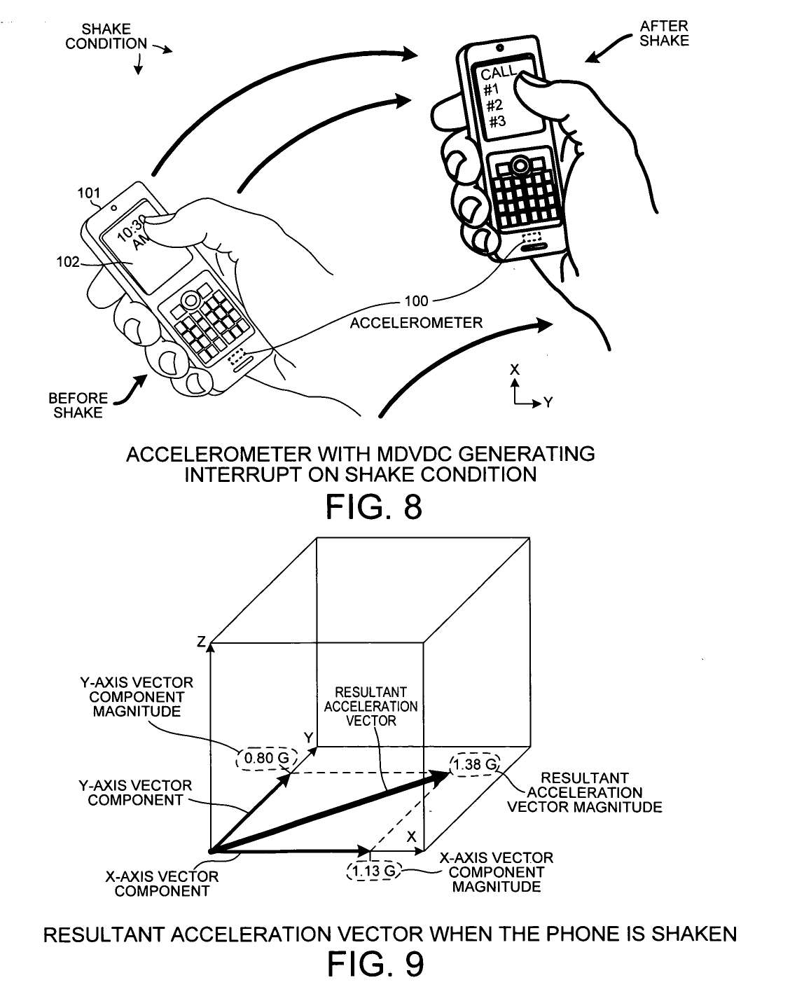

FIG. 8 is a diagram of a user shaking cellular phone 101 of FIG. 1, and causing interrupt circuit 161 to generate an interrupt signal indicating a shake condition. In this example, an 8-bit digital logic value corresponding to 1.2 G is written to REGISTER G, so that whenever the resultant acceleration vector magnitude is greater than 1.2 G, the shake condition will be detected and an interrupt signal will be generated. In this example, the user shakes cellular phone 101 strong enough such that the resultant acceleration vector magnitude calculated by MDVDC 135 is greater than 1.2 G. As a result, processing circuit 161 sets INT1 to a digital logic high value, and supplies the asserted signal INT1 onto interrupt controller 161 of microcontroller 103. As a result of receiving the interrupt signal INT1, interrupt controller 111 of microcontroller 103 invokes Interrupt Service Routine (ISR) 114, and processor 109 executes the instructions stored in ISR 114. In this example, the instructions of ISR 114 renders a Call Speed Dial Contacts Screen on display 102. In this example, shaking cellular phone 101 greater than an acceleration magnitude of 1.2 G toggles the display from a Clock Screen to a Call Speed Dial Contacts Screen.

FIG. 9 is a diagram of the resultant acceleration vector representing the motion of cellular phone 101 at an instant in time during the shake condition of FIG. 8. The resultant acceleration vector has a magnitude of 1.38 G, which is greater than the shake threshold and this indicates that cellular phone 101 is being shaken. The resultant acceleration vector magnitude is computed by MDVDC 135 of FIG. 6 using the X-axis vector component magnitude of 1.13 G (X-MAG CORR), and the Y-axis vector component magnitude of 0.80 G (Y-MAG CORR). In this example, interrupt circuit 161 asserts interrupt signal INT1 to a digital logic high value indicating a shake condition, and causes display 102 of cellular phone 101 to toggle from a Clock Screen to a Call Speed Dial Contacts Screen.

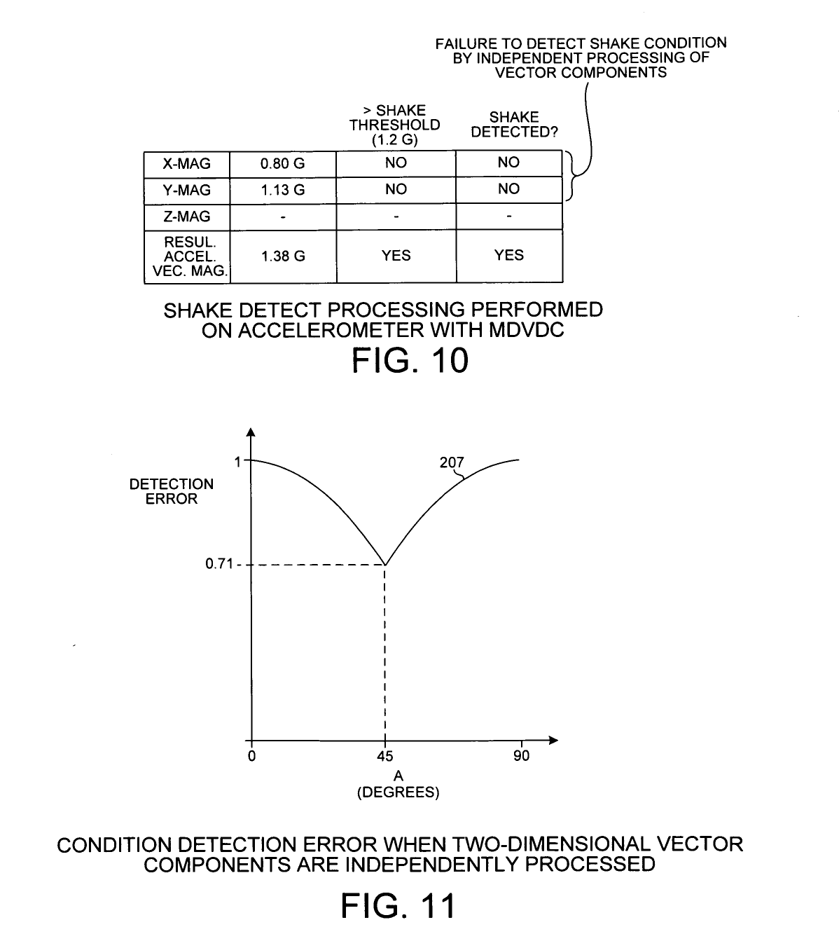

FIG. 10 is a table that shows the acceleration vector component magnitudes and the resultant acceleration vector magnitude representing the motion of cellular phone 101 at an instant in time during the shake condition of FIG. 8. If the acceleration vector component magnitudes are independently processed (by comparing each vector component magnitude to the threshold value), then the shake condition is not detected because neither acceleration vector component magnitude is greater than the shake threshold value. However, the novel technique for determining the resultant acceleration vector magnitude results in the detection of the shake condition.

FIG. 11 is a graph showing the condition detection error in two-dimensions when each vector component is processed independently as opposed to determining the resultant acceleration vector for detecting a condition. Independent processing is a typical technique for event detection and involves comparing each vector component magnitude separately to a threshold for a condition. Graph 207 indicates that in two dimensions, if the angle of the resultant vector is rotated 45 degrees from an axis, then the condition is least likely to be detected when independent processing is performed. However, accelerometer 100 determines a resultant vector and minimizes this detection error, as shown in the following example. Accelerometer 100 of FIG. 2 is configured to detect a resultant acceleration vector along an X-axis and a Y-axis, and is also configured to generate an interrupt when the magnitude of acceleration is greater than a shake threshold of 1.2 G signifying a shake condition. Accelerometer 100 is accelerated, and an X-axis sensing element detects an X-axis vector component magnitude of approximately 0.92 G and a Y-axis sensing element detects a Y-axis vector component magnitude of approximately 0.92 G. MDVDC 135 of accelerometer 100 determines a resultant acceleration vector having a magnitude of 1.3 and an angle of 45 degrees. In this example, an interrupt is generated indicating that a shake condition is detected because 1.3 G is greater than 1.2 G. However, if each vector component is independently processed instead of determining a resultant acceleration vector, then accelerometer 100 will not detect a shake condition because neither vector component magnitude (both 0.92 G) is greater than the threshold value of 1.3 G. A sensor package with a MDVDC is accurate to within twenty percent because the MDVDC determines a precise resultant vector.

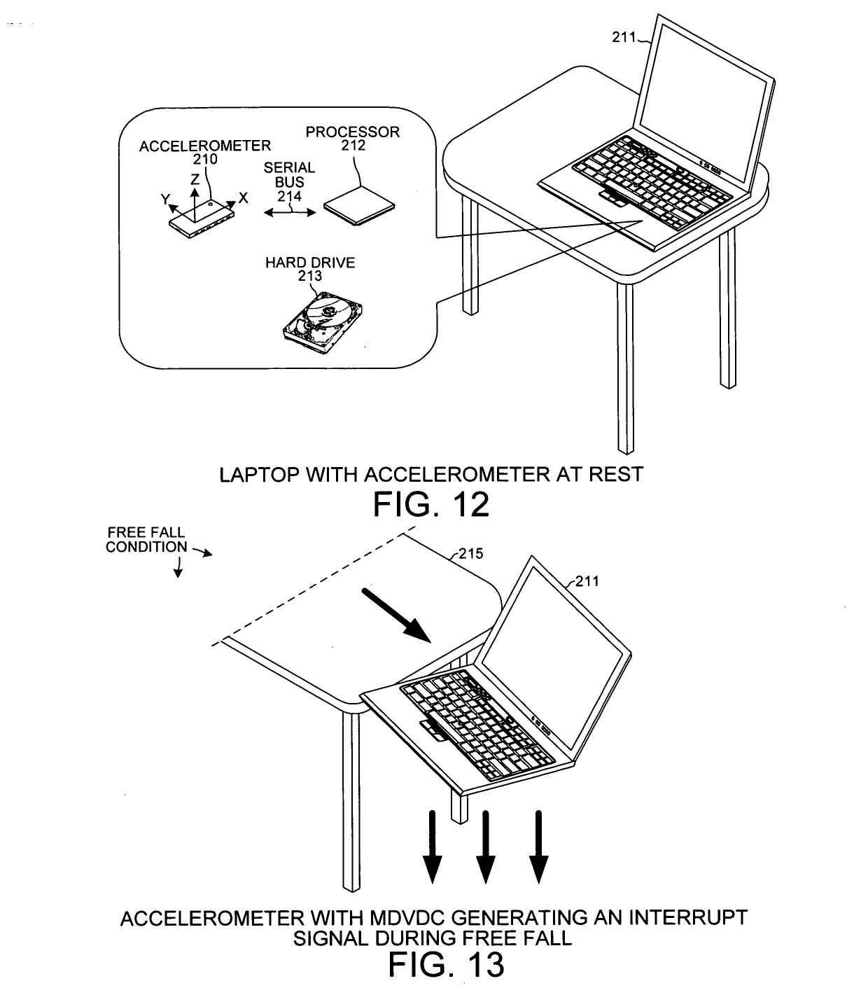

FIG. 12 is a diagram of an accelerometer 210 in a laptop 211 configured to generate an interrupt signal during a free fall condition, in accordance with one novel aspect. Laptop computer 211 includes accelerometer 210, processor 212, and a hard drive 213, among other components. Typically laptop 211 will employ a technique to minimize the likelihood that information stored on hard drive 213 will become corrupted if laptop 211 were to fall from a surface. In this example, accelerometer 210 detects a free fall condition and supplies an interrupt signal to processor 212 via serial bus 214, and processor 212 executes free fall condition instructions to minimize the likelihood of information loss.

FIG. 13 is a diagram of laptop 211 falling off of a surface and in a free fall condition. Upon falling off of table 215, novel accelerometer generates an interrupt signal (not illustrated) indicating that laptop 211 is falling. The interrupt signal is received on processor 212, and processor 212 configures hard drive 213 to help prevent damage and minimize the likelihood of data loss due to the fall.

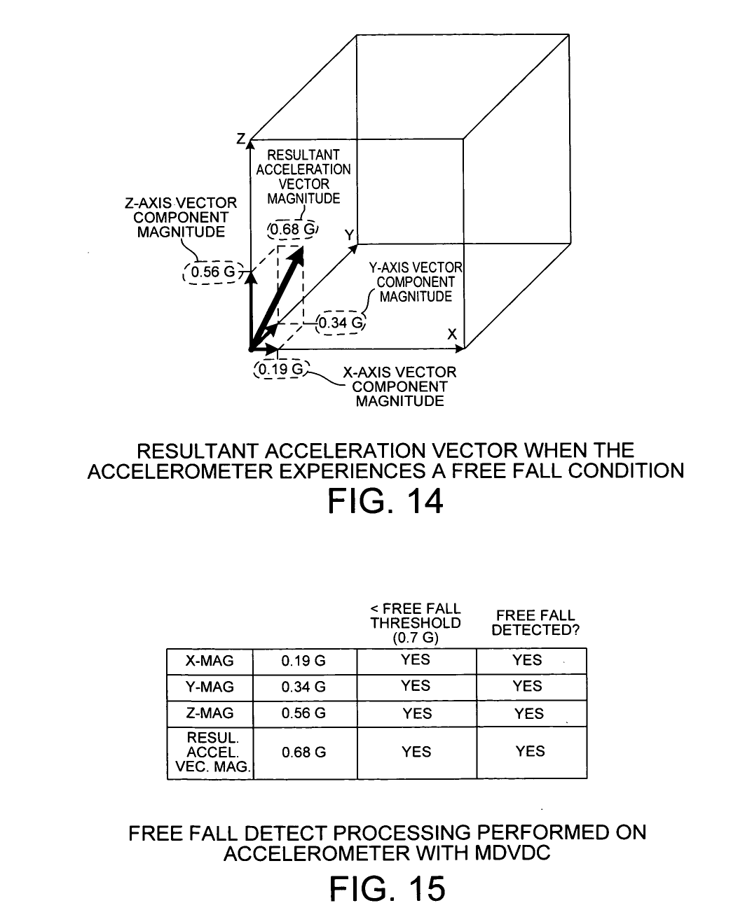

FIG. 14 is a diagram of the resultant acceleration vector representing the motion of laptop 211 at an instant in time during the free fall condition of FIG. 13. In this example, the X-axis vector component magnitude of acceleration is 0.19 G, the Y-axis vector component magnitude of acceleration is 0.34 G, and the Z-axis vector component magnitude of acceleration is 0.56 G. The Multi-Dimensional Vector Determining Circuit (MDVDC) of accelerometer 210 computes a resultant acceleration vector magnitude to be 0.68 G.

FIG. 15 is a table that shows the vector component magnitudes and the resultant acceleration vector magnitude representing the motion of laptop 211 at an instant in time during the free fall condition of FIG. 13.

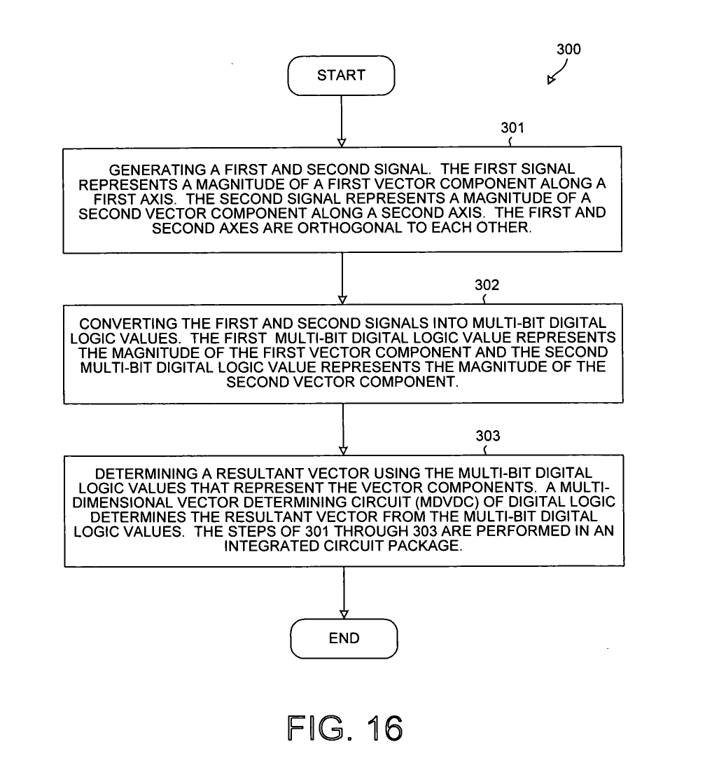

FIG. 16 is a flowchart 300 in accordance with one novel aspect. In a first step (301), a first signal and a second signal are generated. The first signal represents a magnitude of a first vector component of acceleration along a first axis, and the second signal represents a magnitude of a second vector component of acceleration along a second axis. The first axis is orthogonal to the second axis. For example, in FIG. 3, sensing circuit 131 generates signal 141 and signal 142. Signal 141 represents a magnitude of acceleration along X-axis 144, and signal 142 represents a magnitude of acceleration along Y-axis 145. X-axis 144 is orthogonal to Y-axis 145.

In a second step (302), the first and second signals are converted into multi-bit digital logic values representing the vector components of acceleration. For example, in FIG. 3, ADC 132 converts signal 141 into a multi-bit digital logic value X-MAG, and ADC 132 converts signal 142 into a multi-bit digital logic value Y-MAG.

In a third step (303), a Multi-Dimensional Vector Determining Circuit (MDVDC) of digital logic determines a resultant vector from the multi-bit digital logic values.

For example, in FIGS. 8-10, MDVDC 135 receives X-MAG CORR and Y-MAG CORR, and computes MAGNITUDE and ANGLE A, that represent the resultant acceleration vector.

Although certain specific exemplary embodiments are described above in order to illustrate the invention, the invention is not limited to the specific embodiments. For example, MDVDC 135 of FIG. 6 may not utilize a CORDIC circuit to compute a vector magnitude and direction. In another embodiment, determination of the resultant acceleration vector is not performed by processing circuit 133, but rather is determined by a processor, software that implements the CORDIC structure, an iterative shift-and-add circuit, or a Digital Signal Processor (DSP). Also, MDVDC 135 may be an amount of circuitry that represents a state machine structure, or a set of user programmable instruction flow that represents a Coordinate Rotation DIgital Computer (CORDIC) structure. In another embodiment, sensing circuit 132 is a magnetic field sensor, an acceleration sensor, an electric field sensor, or an angular acceleration sensor. Accordingly, various modifications, adaptations, and combinations of various features of the described embodiments can be practiced without departing from the scope of the invention as set forth in the claims.

What is claimed is:

1. A sensor comprising:
a sensing circuit configured to generate a first signal and a second signal, wherein the first signal represents a magnitude of a first vector component detected by the sensor along a first axis, and wherein the second signal represents a magnitude of a second vector component detected by the sensor along a second axis;
an Analog-to-Digital Converter (ADC) configured to convert the first signal into a first multi-bit digital logic value that represents the magnitude of the first vector component, and wherein the ADC is also configured to convert the second signal into a second multi-bit digital logic value that represents the magnitude of the second vector component;
a Multi-Dimensional Vector Determining Circuit (MDVDC) that determines information of a resultant vector, wherein the information of the resultant vector is a function of the first multi-bit digital logic value and the second multi-bit digital logic value, and wherein the resultant vector represents a vector sum of the first vector component and the second vector component; and
an integrated circuit package that contains the sensing circuit, the ADC, and the MDVDC.

2. The sensor of claim 1, wherein the information of the resultant vector is taken from the group consisting of: a vector magnitude, and a vector angle.

3. The sensor of claim 1, wherein the sensor is an accelerometer, wherein the sensing circuit is configured to detect acceleration of the integrated circuit package along the first axis such that the first signal represents a magnitude of acceleration along the first axis, wherein the sensing circuit is also configured to detect acceleration of the integrated circuit package along the second axis such that the second signal represents a magnitude of acceleration along the second axis, wherein the first axis is orthogonal to the second axis, and wherein the resultant vector is a resultant acceleration vector.

4. The sensor of claim 1, wherein the MDVDC is an amount of dedicated hardwired circuitry and includes no user programmable data flow.

5. The sensor of claim 1, wherein the MDVDC is an element taken from the group consisting of: an amount of circuitry that represents a state machine structure, and a set of user programmable instruction flow that represents a Coordinate Rotation DIgital Computer (CORDIC) structure.

6. The sensor of claim 1, wherein the MDVDC includes a Coordinate Rotation DIgital Computer (CORDIC) circuit.

7. The sensor of claim 1, wherein the sensing circuit includes at least one sensing element, wherein the sensing element is taken from the group consisting of: a magnetic field sensor, an acceleration sensor, an electric field sensor, and an angular acceleration sensor.

8. The sensor of claim 1, wherein the MDVDC is contained in a processing circuit, and wherein the processing circuit is configured to supply an interrupt signal onto an interrupt output lead when a value of the information of the resultant vector is greater than a threshold value.

9. The sensor of claim 1, wherein the MDVDC is contained in a processing circuit, and wherein the processing circuit is configured to supply an interrupt signal onto an interrupt output lead when a value of the information of the resultant vector is less than a threshold value.

10. The sensor of claim 1, wherein the MDVDC is contained in a processing circuit, and wherein the processing circuit is configured to supply an interrupt signal onto an interrupt output lead when the sensor undergoes a condition, and wherein the condition is taken from the group consisting of: a shake condition, a free fall condition, and an orientation detect condition.

11. A method comprising:
(a) generating a first signal and a second signal, wherein the first signal represents a magnitude of a first vector component detected by a sensing circuit along a first axis, wherein the second signal represents a magnitude of a second vector component detected by the sensing circuit along a second axis, and wherein the second axis is orthogonal to the first axis;
(b) converting the first signal into a first multi-bit digital logic value that represents the first vector component, and converting the second signal into a second multi-bit digital logic value that represents the second vector component; and
(c) determining information of a resultant vector with a Multi-Dimensional Vector Determining Circuit (MDVDC) of digital logic, wherein the information of the resultant vector is a function of the first multi-bit digital logic value and the second multi-bit digital logic value, and wherein the steps of (a) through (c) are performed in an integrated circuit package.

12. The method of claim 11, wherein the information of the resultant vector is taken from the group consisting of: a vector magnitude, and a vector angle.

13. The method of claim 11, wherein the sensing circuit of step (a) is configured to detect acceleration of the integrated circuit package along the first axis such that the first signal represents a magnitude of acceleration along the first axis, wherein the sensing circuit is also configured to detect acceleration of the integrated circuit package along the second axis such that the second signal represents a magnitude of acceleration along the second axis, and wherein the resultant vector is a resultant acceleration vector.

14. The method of claim 11, wherein the MDVDC of step (c) includes a Coordinate Rotation DIgital Computer (CORDIC) circuit.

15. The method of claim 11, wherein the sensing circuit of step (a) includes at least one sensing element, wherein the sensing element is taken from the group consisting of: a magnetic field sensor, an acceleration sensor, an electric field sensor, and an angular acceleration sensor.

16. The method of claim 11, further comprising the step of:
(d) generating an interrupt signal if a value of the resultant vector information is greater than a threshold value, wherein the interrupt signal is supplied onto a terminal of the integrated circuit package.

17. The method of claim 11, further comprising the step of:
(d) generating an interrupt signal if a value of the resultant vector information is less than a threshold value, wherein the interrupt signal is supplied onto a terminal of the integrated circuit package.

18. An apparatus comprising:
a sensing circuit; and
means for determining a resultant vector, wherein the resultant vector is a function of a first multi-bit digital logic value and a second multi-bit digital logic value, wherein the first multi-bit digital logic value represents a magnitude of a first vector component along a first axis determined by the sensing circuit and the second multi-bit digital logic value represents a magnitude of a second vector component along a second axis determined by the sensing circuit, wherein the first axis is orthogonal to the second axis, and wherein the means and the sensing circuit are contained in an integrated circuit package.

19. The apparatus of claim 18, wherein the means is taken from the group consisting of: a processor, a Coordinate Rotation DIgital Computer (CORDIC) circuit, and an iterative shift-and-add circuit.

20. The apparatus of claim 18, wherein the apparatus is an accelerometer, and wherein the means is also for determining if the accelerometer is experiencing a condition, wherein the condition is taken from the group consisting of: a shake condition, and a free fall condition.
